(19) United States
(12) Patent Application Publication
(10) Pub. No.: US 2024/0067174 A1
(43) Pub. Date: Feb. 29, 2024

(54) VEHICLE SYSTEMS AND METHODS TO LONGITUDINALLY ADJUST LANE POSITIONING

(71) Applicant: GM GLOBAL TECHNOLOGY OPERATIONS LLC, Detroit, MI (US)

(72) Inventors: Paul A. Adam, Milford, MI (US); Jeffrey S. Parks, Ann Arbor, MI (US); Avesta Goodarzi, Whitby (CA); Shaun C. Bowman, Ann Arbor, MI (US)

(73) Assignee: GM GLOBAL TECHNOLOGY OPERATIONS LLC, Detroit, MI (US)

(21) Appl. No.: 17/822,602

(22) Filed: Aug. 26, 2022

(51) Int. Cl. B60W 30/14; B60W 30/095; B60W 30/16; B60W 40/04; B60W 40/105; B60W 60/00

(52) U.S. Cl. CPC B60W 30/143; B60W 30/0956; B60W 30/16; B60W 40/04; B60W 40/105; B60W 60/0015; B60W 2554/402; B60W 2554/80

(57) ABSTRACT

Vehicles and related systems and methods are provided for controlling a vehicle in an autonomous operating mode. One method involves identifying an object in a potential incursion zone corresponding to a lane adjacent to a current lane of travel for the vehicle, determining an estimated time in zone associated with the object, and in response to determining the estimated time in zone is greater than a threshold, determining a longitudinal adjustment strategy to reduce the estimated time in zone associated with the object, determining an adjusted speed for the vehicle in accordance with the longitudinal adjustment strategy, determining a longitudinal trajectory for the vehicle within the current lane of travel based at least in part on the adjusted speed, and autonomously operating one or more actuators onboard the vehicle in accordance with the longitudinal trajectory.

### INTRODUCTION

The technical field generally relates to vehicle systems and more particularly relates to autonomous operation of a vehicle to adjust longitudinal positioning within a lane relative to traffic in an adjacent lane.

An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

Due to the number of different variables in a real-world environment, an autonomous vehicle control system could encounter an environment or scenario where assistance may be desired. For example, in lower-level automation systems (e.g., Level Three or below), traffic, road conditions and other obstacles or scenarios can be encountered that result in automation behavior that deviates from human behavior in a manner that is not intuitive to a driver, and may result in unnecessary intervention by the driver or other vehicle occupant to manually control or operate the vehicle, which is contrary to the intent of the automation and may impair the user experience. Accordingly, it is desirable to provide vehicle control systems and methods that are capable of autonomously responding to certain scenarios in a manner that more closely mimics human driving behavior to improve user experience. Other desirable features and characteristics of the present invention will become apparent from the subsequent detailed description and the appended claims, taken in conjunction with the accompanying drawings and the foregoing technical field and background.

### SUMMARY

Apparatus for a vehicle and related methods for controlling the vehicle in an autonomous operating mode are provided. One method of controlling a vehicle in an autonomous operating mode involves identifying, by a controller associated with the vehicle, an object in a zone relative to the vehicle corresponding to a lane associated with a same direction of travel for the vehicle adjacent to a current lane of travel for the vehicle, determining, by the controller, an estimated amount of time within the zone associated with the object, and in response to determining the estimated amount of time within the zone is greater than a threshold: determining, by the controller, a longitudinal adjustment strategy to reduce the estimated amount of time within the zone associated with the object based at least in part on an estimated distance to a closest in path (CIP) vehicle ahead of the vehicle within the current lane of travel, determining, by the controller, an adjusted speed for the vehicle in accordance with the longitudinal adjustment strategy, determining, by the controller, a longitudinal trajectory for the vehicle within the current lane of travel based at least in part on the adjusted speed, and autonomously operating, by the controller, one or more actuators onboard the vehicle in accordance with the longitudinal trajectory.

In one or more implementations, the method further involves determining longitudinal boundaries for the zone based at least in part on a first speed of the vehicle, wherein determining the estimated amount of time involves determining the estimated amount of time at least a portion of the object will remain within the longitudinal boundaries based at least in part on a relationship between a second speed of the object and the first speed of the vehicle. In a further implementation, the method involves determining an object type associated with the object, wherein determining the longitudinal boundaries involves determining the longitudinal boundaries based at least in part on the first speed of the vehicle and the object type associated with the object and the threshold is influenced by the object type.

In one implementation, the method involves determining an object type associated with the object, wherein the threshold is influenced by the object type. In another implementation, the longitudinal adjustment strategy is a speed up state when the estimated distance is greater than a second threshold and determining the adjusted speed involves temporarily increasing a target speed for the vehicle relative to a set speed for the vehicle in the speed up state. In another implementation, the longitudinal adjustment strategy is a drop back state when a ratio of the estimated distance to the CIP vehicle to a minimum following distance is less than a second threshold and determining the adjusted speed involves temporarily decreasing a target speed for the vehicle relative to a set speed for the vehicle in the drop back state. In yet another implementation, the method further involves detecting the object exiting the zone after autonomously operating the one or more actuators onboard the vehicle in accordance with the longitudinal trajectory determined based at least in part on the adjusted speed and after detecting the object exiting the zone, determining a subsequent longitudinal trajectory for the vehicle within the current lane of travel based at least in part on a set speed for the vehicle, wherein the set speed is different from the adjusted speed, and autonomously operating the one or more actuators onboard the vehicle in accordance with the subsequent longitudinal trajectory.

An apparatus for a vehicle is also provided. The vehicle includes one or more sensing devices onboard the vehicle to obtain sensor data for an object in an adjacent lane and a closest in path (CIP) vehicle ahead of the vehicle within a current lane of travel, one or more actuators onboard the vehicle, and a controller that, by a processor, identifies the object in a zone relative to the vehicle corresponding to the adjacent lane, determines an estimated amount of time within the zone associated with the object, and in response to determining the estimated amount of time within the zone is greater than a threshold, the controller determines a longitudinal adjustment strategy to reduce the estimated amount of time within the zone associated with the object based at least in part on an estimated distance to the CIP vehicle, determines an adjusted speed for the vehicle in accordance with the longitudinal adjustment strategy, determines a longitudinal trajectory for the vehicle within the current lane of travel based at least in part on the adjusted speed, and autonomously operates the one or more actuators onboard the vehicle in accordance with the longitudinal trajectory.

In one implementation, the controller determines an object type associated with the object, wherein the threshold is influenced by the object type. In another implementation, the controller determines longitudinal boundaries for the zone based at least in part on a first speed of the vehicle, wherein determining the estimated amount of time involves determining the estimated amount of time at least a portion of the object will remain within the longitudinal boundaries based at least in part on a relationship between a second speed of the object and the first speed of the vehicle. In a further implementation, the controller determines an object type associated with the object, wherein determining the longitudinal boundaries involves determining the longitudinal boundaries based at least in part on the first speed of the vehicle and the object type associated with the object, and the threshold is influenced by the object type.

In another implementation, the longitudinal adjustment strategy is a speed up state when the estimated distance is greater than a second threshold and the adjusted speed is an increased target speed for the vehicle relative to a set speed for the vehicle in the speed up state. In another implementation, the longitudinal adjustment strategy is a drop back state when a ratio of the estimated distance to the CIP vehicle to a minimum following distance is less than a second threshold and the adjusted speed is a decreased target speed for the vehicle relative to a set speed for the vehicle in the drop back state. In another implementation, the controller detects the object exiting the zone after autonomously operating the one or more actuators onboard the vehicle in accordance with the longitudinal trajectory determined based at least in part on the adjusted speed, and after detecting the object exiting the zone, the controller determines a subsequent longitudinal trajectory for the vehicle within the current lane of travel based at least in part on a set speed for the vehicle and autonomously operates the one or more actuators onboard the vehicle in accordance with the subsequent longitudinal trajectory.

An apparatus for a non-transitory computer-readable medium is also provided. The computer-readable medium includes executable instructions stored that, when executed by a processor, cause the processor to identify an object in a zone relative to a vehicle corresponding to a lane associated with a same direction of travel for the vehicle adjacent to a current lane of travel for the vehicle, determine an estimated amount of time within the zone associated with the object, and in response to determining the estimated amount of time within the zone is greater than a threshold, determine a longitudinal adjustment strategy to reduce the estimated amount of time within the zone associated with the object based at least in part on an estimated distance to a closest in path (CIP) vehicle ahead of the vehicle within the current lane of travel, determine an adjusted speed for the vehicle in accordance with the longitudinal adjustment strategy, determine a longitudinal trajectory for the vehicle within the current lane of travel based at least in part on the adjusted speed, and autonomously operate one or more actuators onboard the vehicle in accordance with the longitudinal trajectory. In one implementation, the executable instructions cause the processor to determine longitudinal boundaries for the zone based at least in part on a first speed of the vehicle, wherein determining the estimated amount of time involves determining the estimated amount of time at least a portion of the object will remain within the longitudinal boundaries based at least in part on a relationship between a second speed of the object and the first speed of the vehicle. In another implementation, the executable instructions cause the processor to determine an object type associated with the object, wherein determining the longitudinal boundaries involves determining the longitudinal boundaries based at least in part on the first speed of the vehicle and the object type associated with the object and the threshold is influenced by the object type. In yet another implementation, the executable instructions cause the processor to determine an object type associated with the object, wherein the threshold is influenced by the object type. In another implementation, the longitudinal adjustment strategy is a speed up state when the estimated distance is greater than a second threshold and the executable instructions cause the processor to temporarily increase a target speed for the vehicle relative to a set speed for the vehicle in the speed up state. In another implementation, the longitudinal adjustment strategy is a drop back state when a ratio of the estimated distance to the CIP vehicle to a minimum following distance is less than a second threshold and the executable instructions cause the processor to temporarily decrease a target speed for the vehicle relative to a set speed for the vehicle in the drop back state.

### BRIEF DESCRIPTION OF THE DRAWINGS

The exemplary aspects will hereinafter be described in conjunction with the following drawing figures, wherein like numerals denote like elements, and wherein:

FIG. 1 is a block diagram illustrating an autonomous vehicle control system for a vehicle in accordance with various implementations;

FIG. 2 is a block diagram of an automated driving system (ADS) suitable for implementation by the autonomous vehicle control system of the vehicle of FIG. 1 in accordance with various implementations;

FIG. 3 depicts a flow diagram of a longitudinal adjustment process suitable for implementation by the ADS of FIG. 2 in the autonomous vehicle control system of FIG. 1 according to one or more aspects described herein;

FIG. 4 depicts a flow diagram of a strategy determination process suitable for implementation by the ADS of FIG. 2 in connection with the longitudinal adjustment process of FIG. 3 according to one or more aspects described herein;

FIGS. 5-6 depict a sequence of different states for an exemplary scenario for an example implementation of the longitudinal adjustment process of FIG. 3 where the host vehicle decelerates to a temporarily decreased speed to drop back longitudinally with respect to another vehicle in an adjacent lane according to one or more aspects described herein; and

FIGS. 7-8 depict a sequence of different states for an exemplary scenario for an example implementation of the longitudinal adjustment process of FIG. 3 where the host vehicle accelerates to a temporarily increased speed to advance longitudinally with respect to another vehicle in an adjacent lane according to one or more aspects described herein.

### DETAILED DESCRIPTION

The following detailed description is merely exemplary in nature and is not intended to limit the application and uses. Furthermore, there is no intention to be bound by any expressed or implied theory presented in the preceding introduction, summary, or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

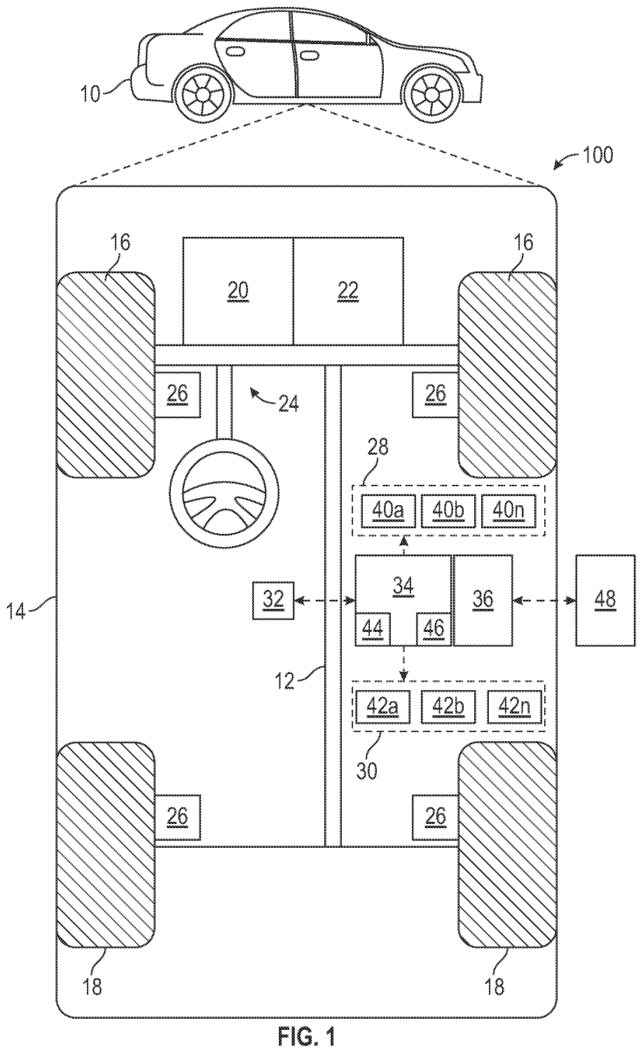

Referring now to FIG. 1, in accordance with one or more implementations, an autonomous vehicle control system 100 determines a plan for autonomously operating a vehicle 10 along a route in a manner that accounts for objects or obstacles detected by onboard sensors 28, 40, as described in greater detail below. In this regard, a control module onboard the vehicle 10 calibrates different types of onboard sensors 28, 40 with respect to one another and/or the vehicle 10, thereby allowing data from those different types of onboard sensors 28, 40 to be spatially associated or otherwise with one another based on the calibration for purposes of object detection, object classification, and the resulting autonomous operation of the vehicle 10.

As depicted in FIG. 1, the vehicle 10 generally includes a chassis, a body 14, and front and rear wheels 16, 18 rotationally coupled to the chassis near a respective corner of the body 14. The body 14 is arranged on the chassis and substantially encloses components of the vehicle 10, and the body 14 and the chassis may jointly form a frame.

In exemplary implementations, the vehicle 10 is an autonomous vehicle or is otherwise configured to support one or more autonomous operating modes, and the control system 100 is incorporated into the vehicle 10 (hereinafter referred to as the vehicle 10). The vehicle 10 is depicted in the illustrated implementation as a passenger car, but it should be appreciated that any other vehicle including motorcycles, trucks, sport utility vehicles (SUVs), recreational vehicles (RVs), marine vessels, aircraft, etc., can also be used. In an exemplary implementation, the vehicle 10 is a so-called Level Two automation system. A Level Two system indicates “partial driving automation,” referring to the driving mode-specific performance by an automated driving system to control steering, acceleration and braking in specific scenarios while a driver remains alert and actively supervises the automated driving system at all times and is capable of providing driver support to control primary driving tasks.

As shown, the vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various implementations, include an internal combustion engine, an electric machine such as a traction motor, and/or a fuel cell propulsion system. The transmission system 22 is configured to transmit power from the propulsion system 20 to the vehicle wheels 16, 18 according to selectable speed ratios. According to various implementations, the transmission system 22 may include a step-ratio automatic transmission, a continuously-variable transmission, or other appropriate transmission. The brake system 26 is configured to provide braking torque to the vehicle wheels 16, 18. The brake system 26 may, in various implementations, include friction brakes, brake by wire, a regenerative braking system such as an electric machine, and/or other appropriate braking systems. The steering system 24 influences a position of the of the vehicle wheels 16, 18. While depicted as including a steering wheel for illustrative purposes, in some implementations contemplated within the scope of the present disclosure, the steering system 24 may not include a steering wheel.

The sensor system 28 includes one or more sensing devices 40a-40n that sense observable conditions of the exterior environment and/or the interior environment of the vehicle 10. The sensing devices 40a-40n can include, but are not limited to, radars, lidars, global positioning systems, optical cameras, thermal cameras, ultrasonic sensors, and/or other sensors. The actuator system 30 includes one or more actuator devices 42a-42n that control one or more vehicle features such as, but not limited to, the propulsion system 20, the transmission system 22, the steering system 24, and the brake system 26. In various implementations, the vehicle features can further include interior and/or exterior vehicle features such as, but are not limited to, doors, a trunk, and cabin features such as air, music, lighting, etc. (not numbered).

The data storage device 32 stores data for use in automatically controlling the vehicle 10. In various implementations, the data storage device 32 stores defined maps of the navigable environment. In various implementations, the defined maps may be predefined by and obtained from a remote system. For example, the defined maps may be assembled by the remote system and communicated to the vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor-based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, implementations of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

In various implementations, one or more instructions of the controller 34 are embodied in the control system 100 (e.g., in data storage element 46) and, when executed by the processor 44, cause the processor 44 to obtain data captured or generated from imaging and ranging devices 40 and utilize the captured environmental data to determine commands for autonomously operating the vehicle 10, as described in greater detail below. In one or more exemplary implementations, the data storage element 46 maintains a lookup table of lateral planning information that may be utilized to determine corresponding lateral reference trajectories for maneuvering laterally into an adjacent lane, with the lateral planning information and resulting reference lateral trajectory being utilized or otherwise referenced by the processor 44 to determine commands for autonomously operating the vehicle 10 when the normal vehicle guidance or control scheme supported by the processor 44 encounters a deadline or other temporal constraint for a time-sensitive lateral maneuver to avoid having to solve for a commanded vehicle path within a limited period of time.

Still referring to FIG. 1, in exemplary implementations, the communication system 36 is configured to wirelessly communicate information to and from other entities 48 over a communication network, such as but not limited to, other vehicles (“V2V” communication,) infrastructure (“V2I” communication), remote systems, and/or personal devices. In an exemplary implementation, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The communication network utilized by the communication system 36 can include a wireless carrier system such as a cellular telephone system that includes a plurality of cell towers (not shown), one or more mobile switching centers (MSCs) (not shown), as well as any other networking components required to connect the wireless carrier system with a land communications system, and the wireless carrier system can implement any suitable communications technology, including for example, digital technologies such as CDMA (e.g., CDMA2000), LTE (e.g., 4G LTE or 5G LTE), GSM/GPRS, or other current or emerging wireless technologies. Additionally, or alternatively, a second wireless carrier system in the form of a satellite communication system can be utilized to provide uni-directional or bi-directional communication using one or more communication satellites (not shown) and an uplink transmitting station (not shown), including, but not limited to satellite radio services, satellite telephony services and/or the like. Some implementations may utilize a land communication system, such as a conventional land-based telecommunications network including a public switched telephone network (PSTN) used to provide hardwired telephony, packet-switched data communications, and the Internet infrastructure. One or more segments of a land communication system can be implemented using a standard wired network, a fiber or other optical network, a cable network, power lines, other wireless networks such as wireless local area networks (WLANs), or networks providing broadband wireless access (BWA), or any combination thereof.

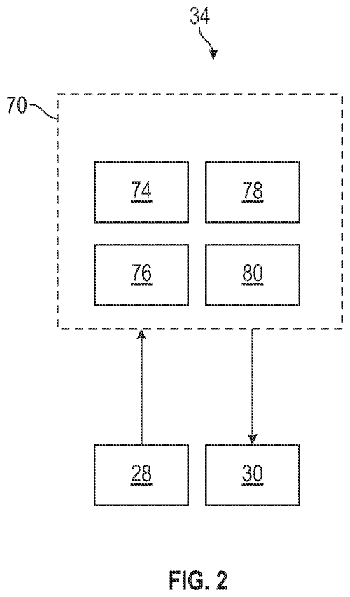

Referring now to FIG. 2, in accordance with various implementations, controller 34 implements an autonomous driving system (ADS) 70. That is, suitable software and/or hardware components of controller 34 (e.g., processor 44 and computer-readable storage device 46) are utilized to provide an autonomous driving system 70 that is used in conjunction with vehicle 10, for example, to automatically control various actuators 30 and thereby control vehicle acceleration, steering, and braking, respectively, without human intervention.

In various implementations, the instructions of the autonomous driving system 70 may be organized by function or system. For example, as shown in FIG. 2, the autonomous driving system 70 can include a sensor fusion system 74, a positioning system 76, a guidance system 78, and a vehicle control system 80. As can be appreciated, in various implementations, the instructions may be organized into any number of systems (e.g., combined, further partitioned, etc.) as the disclosure is not limited to the present examples.

In various implementations, the sensor fusion system 74 synthesizes and processes sensor data and predicts the presence, location, classification, and/or path of objects and features of the environment of the vehicle 10. In various implementations, the sensor fusion system 74 can incorporate information from multiple sensors, including but not limited to cameras, lidars, radars, and/or any number of other types of sensors. In one or more exemplary implementations described herein, the sensor fusion system 74 correlates image data to lidar point cloud data, the vehicle reference frame, or some other reference coordinate frame using calibrated conversion parameter values associated with the pairing of the respective camera and reference frame to relate lidar points to pixel locations, assign depths to the image data, identify objects in one or more of the image data and the lidar data, or otherwise synthesize associated image data and lidar data. In other words, the sensor output from the sensor fusion system 74 provided to the vehicle control system 80 (e.g., indicia of detected objects and/or their locations relative to the vehicle 10) reflects or is otherwise influenced by the calibrations and associations between camera images, lidar point cloud data, and the like.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow given the current sensor data and vehicle pose. The vehicle control system 80 then generates control signals for controlling the vehicle 10 according to the determined path. In various implementations, the controller 34 implements machine learning techniques to assist the functionality of the controller 34, such as feature detection/classification, obstruction mitigation, route traversal, mapping, sensor integration, ground-truth determination, and the like.

In one or more implementations, the guidance system 78 includes a motion planning module that generates a motion plan for controlling the vehicle as it traverses along a route. The motion planning module includes a longitudinal solver module that generates a longitudinal motion plan output for controlling the movement of the vehicle along the route in the general direction of travel, for example, by causing the vehicle to accelerate or decelerate at one or more locations in the future along the route to maintain a desired speed or velocity. The motion planning module also includes a lateral solver module that generates a lateral motion plan output for controlling the lateral movement of the vehicle along the route to alter the general direction of travel, for example, by steering the vehicle at one or more locations in the future along the route (e.g., to maintain the vehicle centered within a lane, change lanes, etc.). The longitudinal and lateral plan outputs correspond to the commanded (or planned) path output provided to the vehicle control system 80 for controlling the vehicle actuators 30 to achieve movement of the vehicle 10 along the route that corresponds to the longitudinal and lateral plans.

During normal operation, the longitudinal solver module attempts to optimize the vehicle speed (or velocity) in the direction of travel, the vehicle acceleration in the direction of travel, and the derivative of the vehicle acceleration in the direction of travel, alternatively referred to herein as the longitudinal jerk of the vehicle, and the lateral solver module attempts to optimize one or more of the steering angle, the rate of change of the steering angle, and the acceleration or second derivative of the steering angle, alternatively referred to herein as the lateral jerk of the vehicle. In this regard, the steering angle can be related to the curvature of the path or route, and any one of the steering angle, the rate of change of the steering angle, and the acceleration or second derivative of the steering angle can be optimized by the lateral solver module, either individually or in combination.

In an exemplary implementation, the longitudinal solver module receives or otherwise obtains the current or instantaneous pose of the vehicle, which includes the current position or location of the vehicle, the current orientation of the vehicle, the current speed or velocity of the vehicle, and the current acceleration of the vehicle. Using the current position or location of the vehicle, the longitudinal solver module also retrieves or otherwise obtains route information which includes information about the route the vehicle is traveling along given the current pose and plus some additional buffer distance or time period (e.g., 12 seconds into the future), such as, for example, the current and future road grade or pitch, the current and future road curvature, current and future lane information (e.g., lane types, boundaries, and other constraints or restrictions), as well as other constraints or restrictions associated with the roadway (e.g., minimum and maximum speed limits, height or weight restrictions, and the like). The route information may be obtained from, for example, an onboard data storage element 32, an online database, or other entity. In one or more implementations, the lateral route information may include the planned lateral path command output by the lateral solver module, where the longitudinal and lateral solver modules iteratively derive an optimal travel plan along the route.

The longitudinal solver module also receives or otherwise obtains the current obstacle data relevant to the route and current pose of the vehicle, which may include, for example, the location or position, size, orientation or heading, speed, acceleration, and other characteristics of objects or obstacles in a vicinity of the vehicle or the future route. The longitudinal solver module also receives or otherwise obtains longitudinal vehicle constraint data which characterizes or otherwise defines the kinematic or physical capabilities of the vehicle for longitudinal movement, such as, for example, the maximum acceleration and the maximum longitudinal jerk, the maximum deceleration, and the like. The longitudinal vehicle constraint data may be specific to each particular vehicle and may be obtained from an onboard data storage element 32 or from a networked database or other entity 48, 52, 54. In some implementations, the longitudinal vehicle constraint data may be calculated or otherwise determined dynamically or substantially in real-time based on the current mass of the vehicle, the current amount of fuel onboard the vehicle, historical or recent performance of the vehicle, and/or potentially other factors. In one or more implementations, the longitudinal vehicle constraint data is calculated or determined in relation to the lateral path, the lateral vehicle constraint data, and/or determinations made by the lateral solver module. For example, the maximum longitudinal speed may be constrained at a particular location by the path curvature and the maximum lateral acceleration by calculating the maximum longitudinal speed as a function of the path curvature and the maximum lateral acceleration (which itself could be constrained by rider preferences or vehicle dynamics). In this regard, at locations where the degree of path curvature is relatively high (e.g., sharp turns), the maximum longitudinal speed may be limited accordingly to maintain comfortable or achievable lateral acceleration along the curve.

Using the various inputs to the longitudinal solver module, the longitudinal solver module calculates or otherwise determines a longitudinal plan (e.g., planned speed, acceleration and jerk values in the future as a function of time) for traveling along the route within some prediction horizon (e.g., 12 seconds) by optimizing some longitudinal cost variable or combination thereof (e.g., minimizing travel time, minimizing fuel consumption, minimizing jerk, or the like) by varying the speed or velocity of the vehicle from the current pose in a manner that ensures the vehicle complies with longitudinal ride preference information to the extent possible while also complying with lane boundaries or other route constraints and avoiding collisions with objects or obstacles. In this regard, in many conditions, the resulting longitudinal plan generated by the longitudinal solver module does not violate the maximum vehicle speed, the maximum vehicle acceleration, the maximum deceleration, and the maximum longitudinal jerk settings associated with the user, while also adhering to the following distances or buffers associated with the user. That said, in some scenarios, violating one or more longitudinal ride preference settings may be necessary to avoid collisions, comply with traffic signals, or the like, in which case, the longitudinal solver module may attempt to maintain compliance of as many of the user-specific longitudinal ride preference settings as possible. Thus, the resulting longitudinal plan generally complies with the user's longitudinal ride preference information but does not necessarily do so strictly.

In a similar manner, the lateral solver module receives or otherwise obtains the current vehicle pose and the relevant route information and obstacle data for determining a lateral travel plan solution within the prediction horizon. The lateral solver module also receives or otherwise obtains lateral vehicle constraint data which characterizes or otherwise defines the kinematic or physical capabilities of the vehicle for lateral movement, such as, for example, the maximum steering angle or range of steering angles, the minimum turning radius, the maximum rate of change for the steering angle, and the like. The lateral vehicle constraint data may also be specific to each particular vehicle and may be obtained from an onboard data storage element 32 or from a networked database or other entity 48, 52, 54. The lateral solver module may also receive or otherwise obtain user-specific lateral ride preference information which includes, for example, user-specific values or settings for the steering rate (e.g., a maximum rate of change for the steering angle, a maximum acceleration of the steering angle, and/or the like), the lateral jerk, and the like. The lateral ride preference information may also include user-specific distances or buffers, such as, for example, a minimum and/or maximum distance from lane boundaries, a minimum lateral buffer or lateral separation distance between objects or obstacles, and the like, and potentially other user-specific lane preferences (e.g., a preferred lane of travel).

Using the various inputs to the lateral solver module, the lateral solver module calculates or otherwise determines a lateral plan for traveling along the route at future locations within some prediction horizon (e.g., 50 meters) by optimizing some lateral cost variable or combination thereof (e.g., minimizing deviation from the center of the roadway, minimizing the curvature of the path, minimizing lateral jerk, or the like) by varying the steering angle or vehicle wheel angle in a manner that ensures the vehicle complies with the lateral ride preference information to the extent possible while also complying with lane boundaries or other route constraints and avoiding collisions with objects or obstacles.

During normal operation, the lateral solver module may utilize the longitudinal travel plan from the longitudinal solver module along with the route information and obstacle data to determine how to steer the vehicle from the current pose within the prediction horizon while attempting to comply with the lateral ride preference information. In this regard, the resulting longitudinal and lateral travel plans that are ultimately output by the motion planning module comply with as many of the user's ride preferences as possible while optimizing the cost variable and avoiding collisions by varying one or more of the vehicle's velocity, acceleration/deceleration (longitudinally and/or laterally), jerk (longitudinally and/or laterally), steering angle, and steering angle rate of change. The longitudinal travel plan output by the motion planning module includes a sequence of planned velocity and acceleration commands with respect to time for operating the vehicle within the longitudinal prediction horizon (e.g., a velocity plan for the next 12 seconds), and similarly, the lateral travel plan output by the motion planning module includes a sequence of planned steering angles and steering rates with respect to distance or position for steering the vehicle within the lateral prediction horizon while operating in accordance with the longitudinal travel plan (e.g., a steering plan for the next 50 meters). The longitudinal and lateral plan outputs are provided to the vehicle control system 80, which may utilize vehicle localization information and employs its own control schemes to generate control outputs that regulate the vehicle localization information to the longitudinal and lateral plans by varying velocity and steering commands provided to the actuators 30, thereby varying the speed and steering of the vehicle 10 to emulate or otherwise effectuate the longitudinal and lateral plans.

In exemplary implementations, the guidance system 78 supports a hands-free autonomous operating mode that controls steering, acceleration and braking while it is enabled and operating to provide lane centering while attempting to maintain a driver-selected set speed and/or following distance (or gap time) relative to other vehicles using the current sensor data (or obstacle data) provided by the sensor fusion system 74 and the current vehicle pose provided by the positioning system 76. For example, the autonomous operating mode may be realized as an adaptive cruise control mode that attempts to maintain the speed of the vehicle substantially constant and equal to a driver-selected set speed while maintaining a desired minimum following distance from a closest in path (CIP) vehicle ahead of the vehicle within a current lane of travel.

As described in greater detail below, in exemplary implementations, while operating in the autonomous operating mode, the guidance system 78 detects, identifies or otherwise determines when another vehicle traveling in the same direction enters a zone alongside the vehicle that increases the likelihood, risk or threat of a potential lateral incursion by that other vehicle, for example, by virtue of the host vehicle potentially being in a blind spot for a driver of that other vehicle. The guidance system 78 calculates or otherwise determines an estimated amount of time during which the other vehicle is expected or predicted to be within the potential lateral incursion zone based at least in part on the speed of the other vehicle relative to the current speed of the host vehicle (which may be equal to the driver-selected set speed). When the estimated amount of time that the vehicle is expected to be within the potential lateral incursion zone is greater than a threshold amount of time, the guidance system 78 automatically determines a longitudinal adjustment strategy for altering the longitudinal position of the host vehicle within the current lane of travel relative to the other vehicle in the adjacent lane in order to reduce the duration of time that vehicle is within the potential lateral incursion zone associated with the host vehicle. In this regard, the longitudinal adjustment strategy accounts for the estimated distance to the CIP vehicle ahead of the vehicle within the current lane of travel (if a detectable CIP vehicle is present), the relative speed difference between the current speed of the host vehicle and the estimated speed of the other vehicle, and potentially other factors, such as, for example, the curvature, geometry or other features of the road, the current state of traffic on the road (e.g., density, variability, and/or the like), and potentially other real-time contextual factors.

In scenarios where the guidance system 78 determines that the longitudinal adjustment strategy should be to enter into a speed up state to overtake, pass or otherwise advance longitudinally within the current lane of travel relative to the position of the other vehicle in the adjacent lane, the guidance system 78 automatically determines or otherwise identifies an adjusted speed for the host vehicle that is greater than the initial or current speed of the host vehicle at the time of detecting the other vehicle in the potential lateral incursion zone. For example, the guidance system 78 may calculate an adjusted speed that is greater than the driver-selected set speed by adding a calibratable or user-configurable factor to the driver-selected set speed or scaling the driver-selected set speed up by a calibratable or user-configurable factor to arrive at an increased speed to be temporarily utilized by the longitudinal solver module to advance the longitudinal position of the host vehicle. In this regard, in the speed up state, the increased speed may be temporarily utilized by the longitudinal solver module as a target speed in lieu of the driver-selected set speed to determine a longitudinal motion plan and corresponding longitudinal trajectory for adjusting the longitudinal position of the host vehicle within the current lane of travel forward relative to the observed longitudinal position of the detected vehicle in the adjacent lane of travel. Once the host vehicle overtakes or passes the detected vehicle in the adjacent lane by an amount that results in the other vehicle exiting the potential lateral incursion zone associated with the host vehicle, the guidance system 78 may automatically revert the target speed for the longitudinal solver module back to the driver-selected set speed or whatever speed target existed prior to detecting the vehicle in the potential lateral incursion zone.

On the other hand, in scenarios where the guidance system 78 determines that the longitudinal adjustment strategy should be to enter into a drop back state to allow the other vehicle to overtake, pass or otherwise advance longitudinally within the adjacent lane of travel relative to the position of the host vehicle (e.g., due to insufficient headway distance between the host vehicle and the CIP vehicle in the current lane), the guidance system 78 automatically determines or otherwise identifies an adjusted speed for the host vehicle that is less than the initial or current speed of the host vehicle (e.g., by subtracting a calibratable or user-configurable factor from the driver-selected set speed or scaling the driver-selected set speed down by a calibratable or user-configurable factor) to arrive at decreased speed to be temporarily utilized by the longitudinal solver module to cause the longitudinal position of the host vehicle to drop back relative to the detected vehicle in the adjacent lane. In this regard, in the drop back state, the decreased speed may be temporarily utilized by the longitudinal solver module as a target speed in lieu of the driver-selected set speed to determine a longitudinal motion plan and corresponding longitudinal trajectory for adjusting the longitudinal position of the host vehicle within the current lane of travel backwards relative to the observed longitudinal position of the detected vehicle in the adjacent lane of travel. Once the other vehicle in the adjacent lane advances by an amount that results in the other vehicle clearing the potential lateral incursion zone (e.g., by overtaking or passing the CIP vehicle), the guidance system 78 may automatically revert the target speed for the longitudinal solver module back to the driver-selected set speed or whatever speed target existed prior to detecting the vehicle in the potential lateral incursion zone.

By virtue of adjusting the longitudinal position of the host vehicle within the current lane of travel to maintain potential lateral incursion zones free of traffic in adjacent lanes, the subject matter described herein allows the guidance system 78 at the host vehicle 10 to reduce the likelihood or risk of potential lateral incursions into the current lane of travel by other vehicles and thereby maintain confident lane centering control and avoid driver interventions or other escalations when the host vehicle 10 encounters a scenario that could otherwise prompt driver intervention. In this regard, autonomously adjusting longitudinal position relative to vehicles or other objects in adjacent lanes imitates human driving behavior, for example, by avoiding prolonged operation within the potential blind spot of a driver of a vehicle in an adjacent lane or alongside large vehicles (e.g., trucks, recreational vehicles, and the like) that pose an increased risk in the event of a lateral incursion into the lane of the host vehicle.

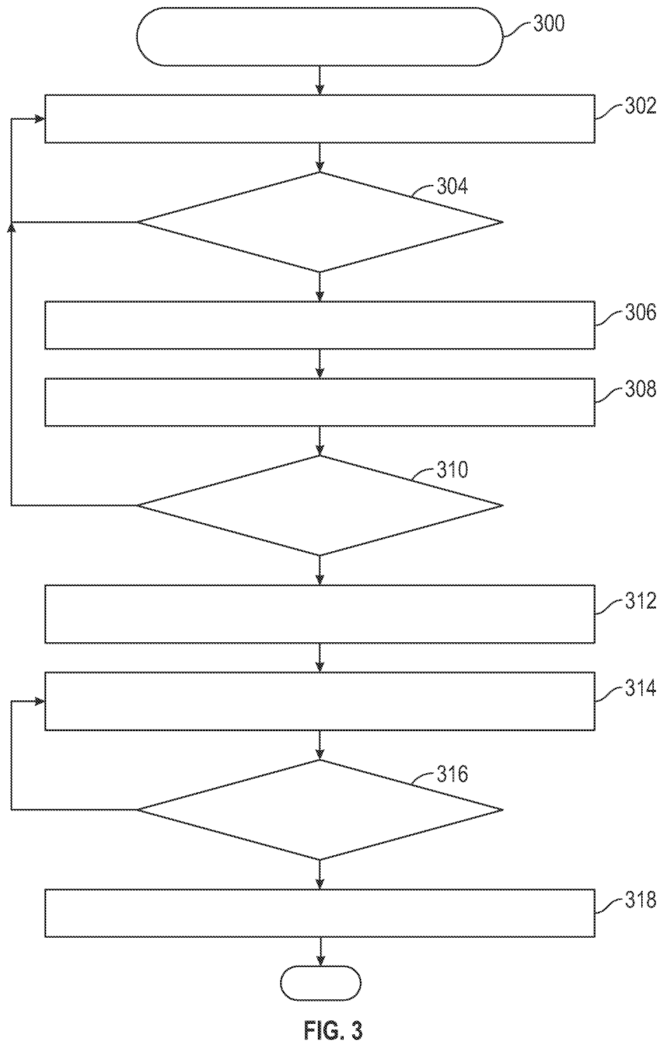

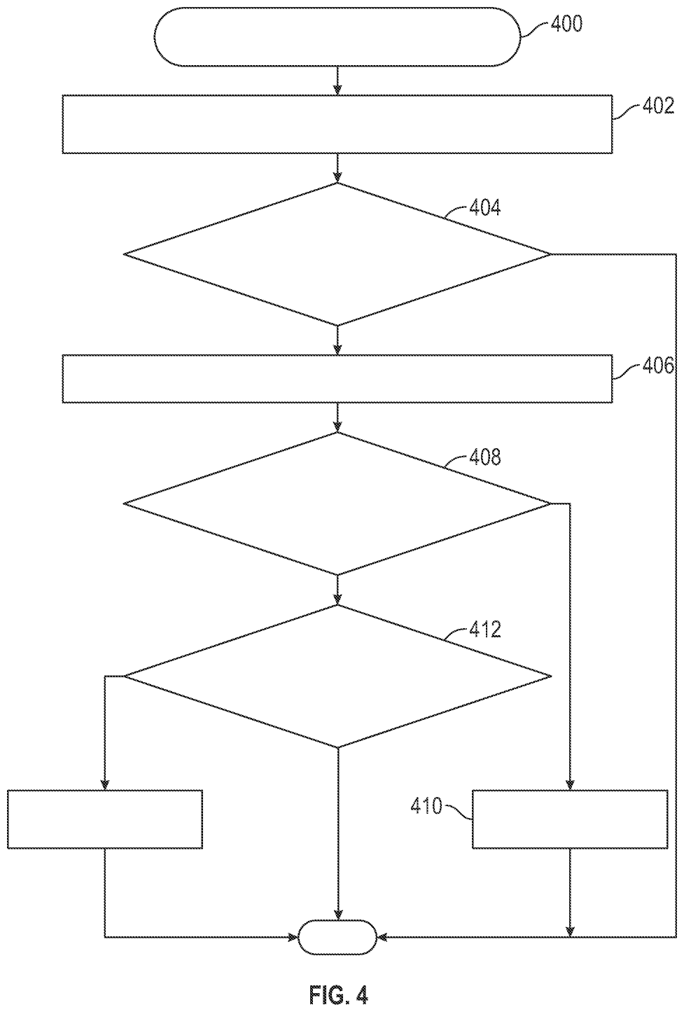

FIG. 3 depicts an exemplary implementation of a longitudinal adjustment process 300 suitable for implementation by a control module onboard a vehicle (e.g., by the guidance system 78 of the ADS 70 supported by the controller 34 in the vehicle 10) to automatically adjust the longitudinal position of the vehicle responsive to a detected object within a potential lateral incursion zone to imitate human driving behavior by mitigating the risk of potential lateral incursions into the current lane of travel. For illustrative purposes, the following description may refer to elements mentioned above in connection with FIGS. 1-2. While portions of the longitudinal adjustment process 300 may be performed by different elements of a vehicle system, for purposes of explanation, the subject matter may be primarily described herein in the context of the longitudinal adjustment process 300 being primarily performed by the guidance system 78 of the ADS 70 implemented by the controller 34 associated with the vehicle 10. In one or more exemplary aspects, the longitudinal adjustment process 300 is performed in connection with the strategy determination process 400 described in greater detail below in the context of FIG. 4.

In exemplary implementations, prior to initiation or execution, the controller 34, the ADS 70, the guidance system 78 or other component implementing or supporting the longitudinal adjustment process 300 verifies or otherwise confirms that one or more enable criteria associated with the longitudinal adjustment process 300 are satisfied prior to enabling the longitudinal adjustment process 300. For example, in one implementation, the ADS 70 and/or the guidance system 78 verifies or otherwise confirms that the current configuration and/or the road type associated with the road satisfy one or more road requirements for enabling the longitudinal adjustment process 300. In this regard, the longitudinal adjustment process 300 may be disabled on two-lane two-way roads or other scenarios where the longitudinal adjustment process 300 is unlikely to reflect human driver behavior when manually operating a vehicle on such roads.

In exemplary implementations, the ADS 70 and/or the guidance system 78 also verifies or otherwise confirms that the curvature, the pitch and/or other geometric characteristics associated with the road at the current location of the vehicle are within a desired range of allowable road characteristics for enabling the longitudinal adjustment process 300. For example, the longitudinal adjustment process 300 may be disabled when the roadway curvature and/or the pitch is greater than a respective threshold indicative of road geometry where the longitudinal adjustment process 300 is unlikely to reflect human driver behavior when manually operating a vehicle in that operating environment.

Additionally, the ADS 70 and/or the guidance system 78 may analyze the data output by the sensor fusion system 74 and potentially other sources of real-time traffic information (e.g., from a remote system or other entity 48 via a communication network) to assess a current traffic pattern associated with the road and verify or otherwise confirm the assessed traffic pattern satisfies a traffic pattern requirement for enabling the longitudinal adjustment process 300. In this regard, the longitudinal adjustment process 300 may be disabled during periods of heavy traffic where mitigation of the risk of potential lateral incursions by longitudinal adjustment is likely to be only transient in nature and potentially disruptive or intrusive to the user experience.

When the enable or entry criteria associated with the longitudinal adjustment process 300 are satisfied, the longitudinal adjustment process 300 initiates or otherwise begins by identifying or otherwise determining one or more potential lateral incursion zones with respect to the host vehicle at 302. In this regard, the ADS 70 and/or the guidance system 78 calculates or otherwise determines longitudinal boundaries that define a zone or region within an adjacent lane to the current lane of travel that corresponds to a potential operating region for another vehicle or object (e.g., a bicycle, pedestrian or the like) within the adjacent lane where an increased risk of a collision with the host vehicle may exist in the event a vehicle or object operating within that zone were to laterally maneuver into the current lane of travel occupied by the host vehicle. The ADS 70 and/or the guidance system 78 calculates or otherwise determines longitudinal boundaries for a potential lateral incursion zone on either or both sides of the host vehicle where there is an adjacent lane for traffic traveling in the same direction as the host vehicle. In exemplary implementations, the longitudinal location of the longitudinal boundaries for the potential incursion zone within the adjacent lane are calculated or otherwise determined relative to the longitudinal position of the host vehicle within the current lane of travel, such that the potential lateral incursion zone(s) effectively travel longitudinally within the adjacent lane of travel in sync with the longitudinal movement of the host vehicle to maintain a substantially fixed relationship with respect to the host vehicle.

In exemplary implementations, the relative position of the longitudinal boundaries are influenced by the current speed of the host vehicle. For example, at faster vehicle speeds, the longitudinal distance between the longitudinal boundaries may increase to encompass a greater region of the adjacent lane to reflect a correlation between perceived risk of an incursion by a driver or other vehicle occupant and the speed of the host vehicle. On the other hand, at slower speeds, the longitudinal distance between the longitudinal boundaries may decrease to reflect a lower perceived risk at slower speeds and decrease sensitivity of the longitudinal adjustment process 300 to reduce the likelihood of unnecessary or nonintuitive longitudinal adjustments that are unlikely to reflect manual human driving behavior at slower speeds. In an exemplary implementation, the ADS 70 and/or the guidance system 78 may maintain or otherwise utilize a lookup table that outputs or otherwise defines the relative longitudinal positions for the longitudinal boundaries for a potential incursion zone with respect to the host vehicle longitudinal position as a function of the current speed of the host vehicle that is utilized to lookup the appropriate lateral boundary locations. That said, in other implementations, the relative longitudinal positions for the longitudinal boundaries may be calculated as a function of the current speed of the host vehicle and potentially other variables that may dynamically vary during operation (e.g., the current roadway geometric characteristics, the current traffic pattern, etc.). In exemplary implementations, the lateral boundaries associated with the potential incursion zone may be calculated or otherwise determined based on the lane boundaries for the adjacent lane and the curvature associated with the roadway at the current location, such that the shape and/or orientation of the potential incursion zone corresponds to the curvature or geometry of the road within the region encompassed by the longitudinal boundaries. In this regard, the subject matter described herein is not limited to any particular size, shape or orientation of the potential incursion zone.

Still referring to FIG. 3, at 304, the longitudinal adjustment process 300 detects or otherwise identifies the presence of an object in an adjacent lane of travel in the same direction that is within a potential lateral incursion zone relative to the host vehicle. In this regard, the ADS 70 and/or the guidance system 78 may continually analyze the output of the sensor fusion system 74 to detect or otherwise identify when at least a portion of a detected object in an adjacent lane enters into a potential lateral incursion zone, for example, by crossing one of the longitudinal boundaries.

In response to detecting an object within a potential lateral incursion zone, the longitudinal adjustment process 300 identifies or otherwise determines an object type associated with the detected object at 306. In this regard, the sensor fusion system 74 may classify or otherwise assign a particular object type or classification to the detected object, such as, for example, passenger car, SUV, truck, RV, motorcycle, bicycle, pedestrian and/or the like, and provide corresponding indicia of the classified object type assigned to the detected object to the guidance system 78.

The illustrated longitudinal adjustment process 300 continues at 308 by calculating or otherwise determining an estimated amount of time that the detected object is expected to be within the potential lateral incursion zone in a manner that is influenced by the assigned object type. In this regard, in one or more exemplary implementations, the ADS 70 and/or the guidance system 78 may dynamically adjust the longitudinal location of one or more of the longitudinal boundaries associated with the potential lateral incursion zone based on the object type and then calculate or otherwise determine the estimated amount of time required for the detected object to clear the boundaries of the adjusted lateral incursion zone based on the relative difference between the current speed of the host vehicle and the estimated speed of the detected object. For example, depending on the object type, the longitudinal dimension of the potential lateral incursion zone may be increased (e.g., for trucks, RVs, or the like) or decreased (e.g., for motorcycles, bicycles, pedestrians, or the like) to reflect manual human driving behavior or aversion with respect to traveling alongside the particular type of object. The sensor data associated with the detected object may also be analyzed to calculate or otherwise determine an estimate of the speed of the detected object or an estimate of the relative speed differential between the speed of the detected object and the current speed of the host vehicle. Based on the relative speed differential, the relative longitudinal position of the longitudinal boundaries of the potential lateral incursion zone and the observed size of the detected object based on the sensor data, the ADS 70 and/or the guidance system 78 calculates or otherwise determines an estimated amount of time required for the entirety of the detected object to clear or otherwise exit the potential lateral incursion zone (e.g., by crossing one of the longitudinal boundaries) assuming the relative speed differential is maintained. For purposes of explanation, the duration of time corresponding to the estimated amount of time required for the detected object to clear or otherwise exit the potential lateral incursion zone may alternatively be referred to herein as the time in zone.

At 310, the longitudinal adjustment process 300 identifies or otherwise determines whether the estimated amount of time within the potential lateral incursion zone is greater than an allowable threshold duration of time. In this regard, when the estimated time in zone for the detected object is less than the threshold duration, the ADS 70 and/or the guidance system 78 determines not to initiate a longitudinal adjustment because the detected object is likely to clear the zone within a sufficiently short amount of time such that the presence of the detected object alongside the host vehicle is unlikely to disturb the driver or other vehicle occupants. In one or more exemplary implementations, the allowable threshold duration of time varies depending on the object type, such that the allowable time in zone threshold may be decreased for certain object types (e.g., trucks, RVs, or the like) where prolonged presence alongside the host vehicle is more likely to be disruptive or uncomfortable to a driver or other vehicle occupant, while the allowable time in zone may be increased for other object types where driver or other vehicle occupant is more likely to tolerate longer presence alongside the host vehicle before intervention. When the estimated time in zone is less than the allowable time in zone, the longitudinal adjustment process 300 may exit or repeat analyzing the output of the sensor fusion system 74 to detect subsequent entry of another object into the potential lateral incursion zone or other changes with respect to the currently detected object and/or the operating environment that may cause the estimated time in zone to violate the allowable time in zone during a subsequent iteration of the longitudinal adjustment process 300.

When the longitudinal adjustment process 300 determines that the estimated time in zone for a detected object exceeds the allowable time in zone for that particular object type, the longitudinal adjustment process 300 identifies or otherwise determines a longitudinal lane positioning adjustment strategy for altering the longitudinal position of the host vehicle within the current lane of travel relative to the detected object at 312. In this regard, as described in greater detail below in the context of FIG. 4, the ADS 70 and/or the guidance system 78 determines whether to cause the host vehicle to speed up or drop back relative to the detected object in the adjacent lane in order to reduce the duration of time that detected object is within the potential lateral incursion zone associated with the host vehicle by speeding up or slowing down until the detected object is no longer present within the potential lateral incursion zone. After determining the appropriate longitudinal lane positioning adjustment strategy for the current operating context, the longitudinal adjustment process 300 autonomously adjusts the vehicle speed in accordance with the identified longitudinal lane positioning adjustment strategy at 314. In this regard, the ADS 70 and/or the guidance system 78 calculates or otherwise adjusted target speed for the host vehicle to be utilized by the longitudinal solver module when determining a longitudinal motion plan and corresponding longitudinal trajectory in accordance with the longitudinal lane positioning adjustment strategy and provides corresponding indicia of the resulting longitudinal trajectory and/or longitudinal motion plan to the vehicle control system 80 that autonomously operates one or more actuators 30 in accordance with the determined longitudinal trajectory and/or longitudinal motion plan to cause the host vehicle to accelerate or decelerate from the current or initial speed of the host vehicle towards the adjusted target speed.

In exemplary implementations, the longitudinal adjustment process 300 utilizes the adjusted speed according to the longitudinal lane positioning adjustment strategy for a temporary period of time until detecting or otherwise identifying when one or more exit criteria for ending the longitudinal adjustment are satisfied at 316 before reverting to autonomously operating the vehicle in accordance with a set speed that was previously defined for the vehicle at 318. In one or more exemplary implementations, the ADS 70 and/or the guidance system 78 analyzes the output of the sensor fusion system 74 to detect or otherwise identify an exit condition in response to detecting the detected object crossing one of the longitudinal boundaries of the potential lateral incursion zone or otherwise exiting the potential lateral incursion zone. In this regard, once the speed up or drop back state implemented by the guidance system 78 has successfully repositioned the host vehicle longitudinally within the current lane of travel relative to the detected object in the adjacent lane by a sufficient amount to cause the detected object to clear the potential lateral incursion zone, the guidance system 78 may automatically terminate the longitudinal adjustment and revert the target speed utilized by the longitudinal solver module back to the driver's previously defined set speed or whatever the initial target speed for the host vehicle was prior to determining to initiate the longitudinal adjustment. In exemplary implementations, the ADS 70 and/or the guidance system 78 verifies or otherwise confirms that the detected object has cleared the potential lateral incursion zone by at least a threshold distance, or in other words, that the distance between the detected object and the nearest longitudinal boundary of the potential lateral incursion zone is greater than the threshold distance before terminating the longitudinal adjustment strategy. In this regard, by ensuring the detected object has cleared the zone by at least a threshold distance, the longitudinal adjustment process 300 reduces the likelihood of subsequent or successive longitudinal adjustments for the same detected object.

Since the longitudinal adjustment results in fluctuations in the host vehicle speed, to reduce the likelihood of the longitudinal adjustments interfering with or otherwise disrupting the user experience (e.g., by noticeably deviating from the driver's previously configured set speed), in one or more implementations, the longitudinal adjustment process 300 also employs one or more counters or timers to limit the duration and/or frequency of longitudinal adjustments. In one or more implementations, the ADS 70 and/or the guidance system 78 initializes a timer upon adjusting the target speed for the longitudinal solver module and detects or otherwise identifies an exit condition when the value of the timer corresponds to an activation duration for the identified longitudinal adjustment strategy that is greater than an allowable threshold duration, independent of whether or not the potential lateral incursion zone has been cleared. For example, in one implementation, the ADS 70 and/or the guidance system 78 deactivates or otherwise terminates a longitudinal adjustment strategy when the duration for which the respective strategy has been activated is greater than an allowable threshold duration of 30 seconds by restoring the target speed input to the longitudinal solver module back to the driver's set speed.

Additionally, the ADS 70 and/or the guidance system 78 may implement a counter or similar feature to track the number of times that a longitudinal adjustment strategy has been activated over a preceding window of time. When the number of times a longitudinal adjustment strategy has been employed over a preceding monitoring window of time (e.g., over the previous three minutes) is greater than a threshold allowable number of times (e.g., more than four), the ADS 70 and/or the guidance system 78 deactivates or otherwise terminates any currently active longitudinal adjustment strategy at 316 and/or prevents reactivation of the longitudinal adjustment process 300 until the number of times a longitudinal adjustment strategy has been employed over the preceding monitoring window is less than the threshold. In this regard, one of the enable criteria associated with the longitudinal adjustment process 300 may require the ADS 70 and/or the guidance system 78 verifying or otherwise confirming that the frequency of implementing longitudinal adjustment strategies over the preceding monitoring window is less than the maximum allowable frequency to avoid excessive longitudinal adjustments that could degrade the user experience.

In one or more implementations, to avoid sequentially reactivating a speed up longitudinal adjustment strategy, the ADS 70 and/or the guidance system 78 analyzes the output of the sensor fusion system 74 to detect or otherwise identify additional objects ahead of the detected object in the adjacent lane and calculate or otherwise determine whether another object ahead of the detected object (e.g., the CIP vehicle ahead of the vehicle in the adjacent lane) is likely to enter the potential lateral incursion zone after the detected object clears the potential lateral incursion zone. When a subsequent reactivation of the speed up longitudinal adjustment strategy is expected or likely based on the estimated future incursion of another detected object into the potential lateral incursion zone, the ADS 70 and/or the guidance system 78 may determine that an exit condition does not exist at 316 to maintain the increased target speed input to the longitudinal solver module, even if the detected object has cleared the potential lateral incursion zone (e.g., by crossing the rear longitudinal boundary of the potential lateral incursion zone). In this manner, the longitudinal adjustment process 300 may effectively combine or string together what might otherwise be separate activations of the speed up longitudinal adjustment strategy into a continuous activation period. That said, once the duration of the continuous activation period is greater than the allowable activation duration (e.g., 30 seconds), the ADS 70 and/or the guidance system 78 deactivates or otherwise terminates the speed up longitudinal adjustment strategy and reverts the target speed input to the longitudinal solver module back to the driver's set speed to avoid a prolonged deviation above the set speed that could otherwise degrade the user experience.

FIG. 4 depicts an exemplary implementation of a strategy determination process 400 suitable for implementation by a control module onboard a vehicle (e.g., by the guidance system 78 of the ADS 70 supported by the controller 34 in the vehicle 10) to determine how to adjust the longitudinal position of the vehicle with respect to a detected object in an adjacent lane of travel. For purposes of explanation, the subject matter may be primarily described herein in the context of the strategy determination process 400 being primarily performed by the guidance system 78 of the ADS 70 implemented by the controller 34 associated with the vehicle 10. In one or more exemplary aspects, the strategy determination process 400 is performed in connection with the longitudinal adjustment process 300 (e.g., at 312) described above in the context of FIG. 3.

The strategy determination process 400 begins by identifying or otherwise determining the relative speed difference with respect to the detected object in the potential lateral incursion zone at 402 and verifying or otherwise confirming the relative speed difference is within an allowable range for performing a longitudinal adjustment at 404. Based on the change in the relative longitudinal position of the detected object with respect to the host vehicle over time observed by the sensor fusion system 74, the ADS 70 and/or the guidance system 78 may calculate or otherwise determine the corresponding longitudinal speed of the detected object, and then verify that the speed difference between the host vehicle speed and the detected object speed is within a threshold range of values. In this regard, when the speed difference between the host vehicle and a detected vehicle in an adjacent lane is greater than a threshold amount or otherwise outside the allowable range of values for which the longitudinal adjustment is enabled, the strategy determination process 400 exits and does not select or otherwise enable a longitudinal adjustment strategy because the relative speed difference between the vehicles is likely to result in the detected vehicle clearing the potential lateral incursion zone without adjusting the speed of the host vehicle.

In one or more implementations, in addition to verifying the speed difference is within an allowable range of values, the ADS 70 and/or the guidance system 78 also verifies that the longitudinal distance between the longitudinal position of the host vehicle and the longitudinal position of the detected object in the adjacent lane is less than a threshold value, which is determined as a function of the difference between the driver's set speed and the estimated speed of the detected object (e.g., using a lookup table). In this regard, when the longitudinal distance is greater than the threshold, the strategy determination process 400 may similarly exit without selecting or enabling a longitudinal adjustment strategy because longitudinal distance may reduce the likelihood of the presence of the detected object at its current longitudinal position relative to the host vehicle disturbing a driver or other vehicle occupant, while also increasing the likelihood that the detected vehicle might clear the potential lateral incursion zone without adjusting the speed of the host vehicle.

When the strategy determination process 400 determines the speed difference between the host vehicle and the detected object indicates desirability for a longitudinal adjustment, the strategy determination process 400 continues by estimating or otherwise determining the distance between the host vehicle and the CIP vehicle ahead of the host vehicle in the current lane of travel at 406. When the strategy determination process 400 determines the estimated distance between the CIP vehicle and the host vehicle is greater than a threshold buffer distance at 408 (or when there is no CIP vehicle within detectable range), the strategy determination process 400 determines the host vehicle should implement a speed up longitudinal adjustment strategy and temporarily increases the target speed for the host vehicle to enter a speed up state at 410. In one implementation, the threshold buffer distance is determined by adding an offset to a desired minimum following distance from the CIP vehicle (which may have been previously defined by the driver) that is configured such that the execution of the speed up longitudinal adjustment strategy is unlikely to result in the host vehicle violating that minimum following distance from the CIP vehicle, and thereby improves safety and user experience by reducing risks of lateral incursions.

As described above in the context of FIG. 3, to implement the speed up longitudinal adjustment strategy while in an autonomous operating mode using a driver's set speed, the guidance system 78 provides an increased target speed to the longitudinal solver module in lieu of the previously input set speed to cause the longitudinal solver module to determine a corresponding longitudinal trajectory that results in the host vehicle accelerating. In one or more implementations, the guidance system 78 calculates or otherwise determines the increased speed target by adding a constant to the driver's set speed. In another implementation, the guidance system 78 identifies the increased speed target as the minimum value from among the driver's set speed plus a constant, the current speed limit plus the constant, the current host vehicle speed plus the constant and a maximum allowable speed associated with the autonomous operating mode.

On the other hand, when the estimated distance between the CIP vehicle and the host vehicle is less than the threshold buffer distance at 408, the strategy determination process 400 determines that a speed up longitudinal adjustment strategy should not be implemented because it would decrease the distance to the CIP vehicle by an amount that would offset the benefits of the detected object clearing the potential lateral incursion zone. Instead, the strategy determination process 400 calculates or otherwise determines a follow distance ratio based on a relationship between the estimated distance to the CIP vehicle and a targeted following distance at 412, for example, by dividing the estimated distance to the CIP by the desired minimum following distance from the CIP vehicle. When the strategy determination process 400 determines the follow distance ratio is less than a threshold, the strategy determination process 400 determines the host vehicle should implement a drop back longitudinal adjustment strategy and temporarily decreases the target speed for the host vehicle to enter a drop back state at 414. In this regard, a follow distance ratio value less than the threshold indicates a state where the host vehicle dropping back longitudinally with respect to both the CIP vehicle and the detected object reduces both the forward and lateral incursion risks and is therefore likely to improve user experience and safety.

As described above in the context of FIG. 3, to implement the drop back longitudinal adjustment strategy while in an autonomous operating mode using a driver's set speed, the guidance system 78 provides a decreased target speed to the longitudinal solver module in lieu of the previously input set speed to cause the longitudinal solver module to determine a corresponding longitudinal trajectory that results in the host vehicle decelerating. In one or more implementations, the guidance system 78 calculates or otherwise determines the decreased speed target by subtracting a constant from the driver's set speed.

In some implementations, prior to performing a drop back adjustment, the strategy determination process 400 also determines the estimated distance between the host vehicle and the nearest vehicle behind the host vehicle within the current lane of travel to verify that the host vehicle is greater than a threshold buffer distance ahead of the nearest vehicle to the rear of the host vehicle prior to initiating a drop back adjustment. In this regard, in such implementations, when another vehicle is to the rear of the host vehicle in the current lane of travel and is within a threshold buffer distance, the strategy determination process 400 may exit or otherwise determine not to initiate a drop back longitudinal adjustment strategy because the rearward incursion risk may offset any benefits to be achieved by causing the host vehicle to decelerate to reduce lateral incursion risk.

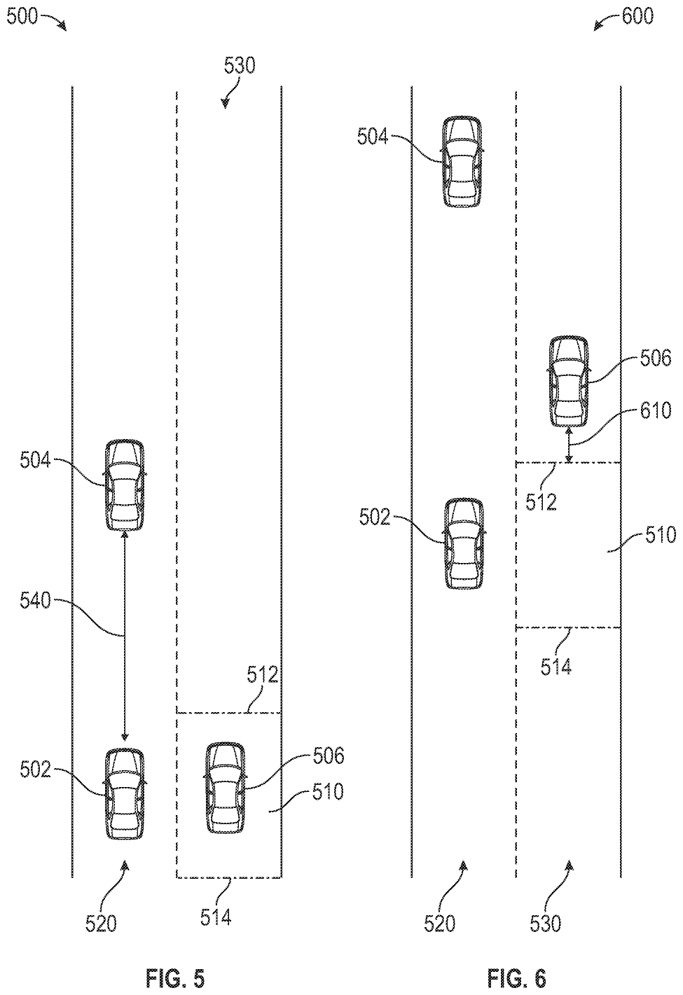

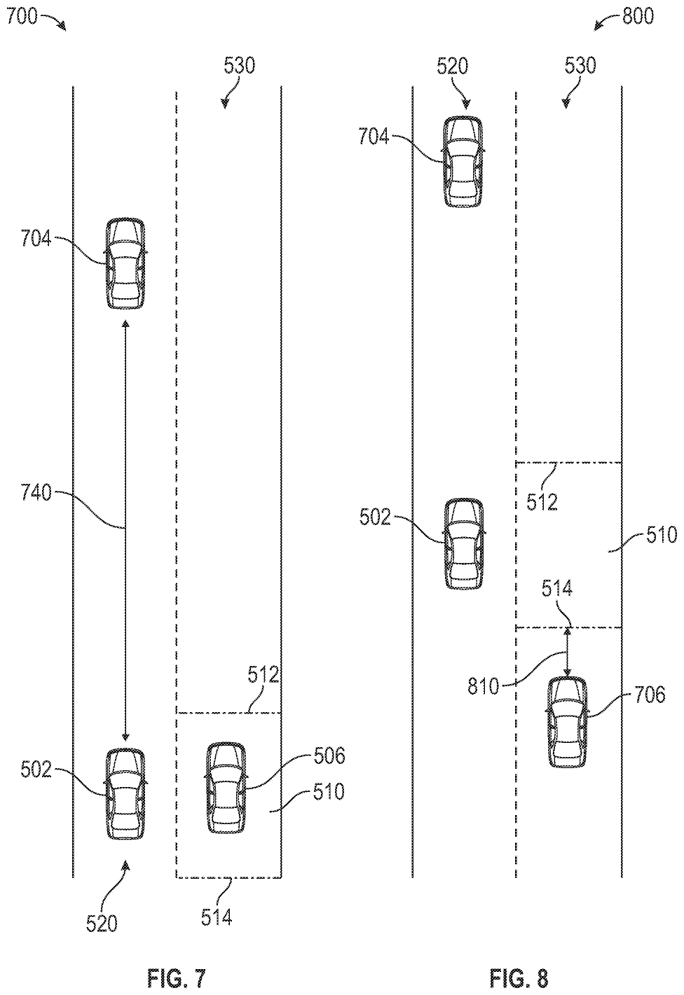

FIGS. 5-8 depict exemplary sequences of scenarios illustrating the longitudinal adjustment process 300 of FIG. 3 implemented at a host vehicle 502, which could be an instance of vehicle 10, that is autonomously traveling along a road while being operated in a Level Two autonomous operating mode that attempts to maintain the vehicle 502 substantially centered within the current lane of travel along the lane centerline at a user-defined set speed, subject to other user-defined or user-configurable constraints (e.g., minimum following distances or other separation distances from other vehicles and the like). In this regard, FIGS. 5-6 depict a scenario where the strategy determination process 400 determines that the longitudinal adjustment process 300 should implement a speed up longitudinal adjustment strategy, while FIGS. 7-8 depict an alternative scenario where the strategy determination process 400 determines that the longitudinal adjustment process 300 should implement a drop back longitudinal adjustment strategy.

FIG. 5 depicts an initial state 500 of the vehicle 502 traveling along a two-lane one-way road (e.g., a segment of an interstate highway or other divided highway) within the left lane 520 behind another vehicle 504 while being operated in an autonomous operating mode that attempts to maintain the vehicle 502 substantially centered within the current lane 520 of travel along the lane centerline at a substantially constant speed corresponding to the driver's set speed. FIG. 5 depicts a CIP vehicle 504 in the left lane 520 that is ahead of the host vehicle 502 and another vehicle 506 traveling in the right lane 530 alongside the host vehicle 502. In this regard, the vehicle 506 is detected or otherwise identified as being present within a potential lateral incursion zone 510 corresponding to the right lane 530 adjacent to the host vehicle 502. As described above, the potential lateral incursion zone 510 is defined by a forward longitudinal boundary 512 and a rearward longitudinal boundary 514 that are calculated or otherwise determined relative to the longitudinal position of the host vehicle 502 by the ADS 70 and/or guidance system 78 at the host vehicle 502 based at least in part on the current speed of the host vehicle 502 (e.g., at 302). In this regard, at faster speeds, the longitudinal distance between the longitudinal boundaries 512, 514 may increase to correspondingly increase the size of the potential lateral incursion zone 510 to account for increased risk at faster speeds, while the longitudinal distance between the longitudinal boundaries 512, 514 may decrease at slower speeds to correspondingly decrease the size of the potential lateral incursion zone 510 to avoid nonintuitive adjustments that do not comport with human factors or expected driving behavior. Additionally, in situations where the road is curved, the ADS 70 and/or guidance system 78 may utilize the roadway curvature at the host vehicle location to correspondingly alter the shape of the potential lateral incursion zone to better conform to the adjacent lane. Thus, it will be appreciated that the subject matter described herein is not limited to any particular size, shape or dimensions of the potential lateral incursion zone. Additionally, it should be noted that in practice, multiple potential lateral incursion zones may be present on both sides of the host vehicle when the host vehicle is traveling on a road with adjacent lanes of traffic on both sides of the host vehicle traveling in the same direction.

FIGS. 5-6 depict a scenario where the host vehicle 502 detects the vehicle 506 in the potential lateral incursion zone 510 (e.g., at 304), classifies the vehicle 506 as a passenger sedan (e.g., at 306), and calculates or otherwise determines an estimated time the vehicle 506 is expected to remain within the potential lateral incursion zone 510 (e.g., at 308) that is greater than an allowable time in zone threshold duration of time (e.g., at 310) before determining to implement a longitudinal lane positioning adjustment strategy (e.g., at 312).

As described above in the context of FIG. 4, after determining the relative speed difference between the host vehicle 502 and the adjacent vehicle 506 are within the allowable range and other enable criteria for a longitudinal adjustment are satisfied (e.g., at 402 and 404), the ADS 70 and/or guidance system 78 at the host vehicle 502 estimates the distance 540 to the CIP vehicle 504. In this regard, FIG. 5 depicts a scenario where the estimated distance 540 to the CIP vehicle 504 is less than the threshold buffer distance for a speed up adjustment (e.g., at 408) and the follow distance ratio with respect to the CIP vehicle 504 is less than a threshold (e.g., at 412) such that the host vehicle 502 should temporarily decrease the target speed utilized by the autonomous operating mode (e.g., at 414) to perform a drop back longitudinal adjustment. In this regard, FIG. 6 depicts an updated state 600 of the vehicles 502, 504, 506 in relation to one another after autonomously operating the host vehicle 502 in accordance with a decreased target speed for the longitudinal solver module (e.g., at 314) to cause the host vehicle 502 to decelerate and drop back longitudinally relative to the adjacent vehicle 506 in the right lane 530 and allow the other vehicle 506 to advance its longitudinal position forward relative to the longitudinal position of the host vehicle 502.

As described above, the decreased target speed for the drop back state may be maintained until the other vehicle 506 clears the potential lateral incursion zone 510 by the entirety of the vehicle 506 crossing the forward longitudinal boundary 512 by at least a threshold distance 610 before determining that the longitudinal adjustment can be terminated (e.g., at 316). Thereafter, the ADS 70 and/or the guidance system 78 at the host vehicle 502 reverts to implementing the autonomous operating mode using the driver's set speed that the host vehicle 502 was initially traveling at in the initial state 500 prior to implementing the longitudinal adjustment strategy (e.g., at 318) to cause the host vehicle 502 to accelerate back to the driver's set speed. In this manner, the longitudinal adjustment process 300 operates to keep the potential lateral incursion zone 510 clear of traffic in the adjacent lane to improve passenger comfort while reducing the risks of a potential lateral incursion from a vehicle or other object in the adjacent lane into the current lane of travel.

FIGS. 7-8 depict an alternative scenario where in the initial state 700, the estimated distance 740 between the host vehicle 502 and the CIP vehicle 704 in the left lane 520 is greater than the threshold buffer distance for a speed up adjustment (e.g., at 408). Accordingly, when the estimated time in zone for the detected vehicle 706 in the adjacent lane 530 is greater than the allowable time in zone threshold and other enable criteria for a longitudinal adjustment are satisfied, the ADS 70 and/or the guidance system 78 at the host vehicle 502 determines that the host vehicle 502 should temporarily increase the target speed utilized by the autonomous operating mode (e.g., at 410) to perform a speed up longitudinal adjustment. In this regard, FIG. 8 depicts an updated state 800 of the vehicles 502, 704, 706 in relation to one another after autonomously operating the host vehicle 502 in accordance with an increased target speed for the longitudinal solver module (e.g., at 314) to cause the host vehicle 502 to accelerate and advance its position longitudinally relative to the adjacent vehicle 506 in the right lane 530. As described above, the increased target speed for the speed up state may be maintained until the other vehicle 706 clears the potential lateral incursion zone 510 by the entirety of the vehicle 706 crossing the rearward longitudinal boundary 514 by at least a threshold distance 810 before determining that the longitudinal adjustment can be terminated (e.g., at 316). Thereafter, the ADS 70 and/or the guidance system 78 at the host vehicle 502 reverts to implementing the autonomous operating mode using the driver's set speed that the host vehicle 502 was initially traveling at in the initial state 500 prior to implementing the longitudinal adjustment strategy (e.g., at 318) to cause the host vehicle 502 to decelerate back to the driver's set speed.

It will be appreciated the subject matter described herein provides nonintrusive autonomous adjustments to the host vehicle longitudinal positioning within a current lane of travel with respect to other vehicles or objects in adjacent lanes to reduce the amount of time during which vehicles or objects are traveling alongside the host vehicle, and thereby reduces the risks of potential lateral incursions from such vehicles or objects. In exemplary implementations, the longitudinal adjustment processes described herein formulate a real-time understanding of the road geometry, road features, and traffic characteristics (e.g., density, variability, and the like) while also assessing adjacent vehicles or objects (e.g., classifying object type, relative speed difference, behavior, and the like) to dynamically determine a potential lateral incursion zone that may vary in shape, size and/or dimensions based on the real-time speed of the host vehicle, the real-time road geometry or characteristics and/or the type of detected object adjacent to the host vehicle. When a detected object is expected to linger or otherwise remain within the dynamically determined potential lateral incursion zone for more than an allowable threshold duration of time, the longitudinal adjustment processes dynamically determine how to adjust the longitudinal position of the host vehicle, by accelerating, decelerating or maintaining constant speed, in a manner that reflects the current real-time operating context and the relationship between the host vehicle, other in path vehicles, traffic, and/or the like. Additionally, multiple longitudinal adjustments may be performed sequentially in a continuous manner to cause the host vehicle to temporarily accelerate to overtake multiple vehicles or objects in the adjacent lane before reverting to the driver's set speed once the potential lateral incursion zone(s) have been adequately cleared.

While at least one exemplary aspect has been presented in the foregoing detailed description, it should be appreciated that a vast number of variations exist. It should also be appreciated that the exemplary aspect or exemplary aspects are only examples, and are not intended to limit the scope, applicability, or configuration of the disclosure in any way. Rather, the foregoing detailed description will provide those skilled in the art with a convenient road map for implementing the exemplary aspect or exemplary aspects. It should be understood that various changes can be made in the function and arrangement of elements without departing from the scope of the disclosure as set forth in the appended claims and the legal equivalents thereof.

What is claimed is:

1. A method of controlling a vehicle in an autonomous operating mode, the method comprising:
identifying, by a controller associated with the vehicle, an object in a zone relative to the vehicle corresponding to a lane associated with a same direction of travel for the vehicle adjacent to a current lane of travel for the vehicle;
determining, by the controller, an estimated amount of time within the zone associated with the object; and
in response to determining the estimated amount of time within the zone is greater than a threshold:
determining, by the controller, a longitudinal adjustment strategy to reduce the estimated amount of time within the zone associated with the object based at least in part on an estimated distance to a closest in path (CIP) vehicle ahead of the vehicle within the current lane of travel;
determining, by the controller, an adjusted speed for the vehicle in accordance with the longitudinal adjustment strategy;
determining, by the controller, a longitudinal trajectory for the vehicle within the current lane of travel based at least in part on the adjusted speed; and
autonomously operating, by the controller, one or more actuators onboard the vehicle in accordance with the longitudinal trajectory.

2. The method of claim 1, further comprising determining longitudinal boundaries for the zone based at least in part on a first speed of the vehicle, wherein determining the estimated amount of time comprises determining the estimated amount of time at least a portion of the object will remain within the longitudinal boundaries based at least in part on a relationship between a second speed of the object and the first speed of the vehicle.

3. The method of claim 2, further comprising determining an object type associated with the object, wherein:
determining the longitudinal boundaries comprises determining the longitudinal boundaries based at least in part on the first speed of the vehicle and the object type associated with the object; and
the threshold is influenced by the object type.

4. The method of claim 1, further comprising determining an object type associated with the object, wherein the threshold is influenced by the object type.

5. The method of claim 1, wherein:
the longitudinal adjustment strategy comprises a speed up state when the estimated distance is greater than a second threshold; and
determining the adjusted speed comprises temporarily increasing a target speed for the vehicle relative to a set speed for the vehicle in the speed up state.

6. The method of claim 1, wherein:
the longitudinal adjustment strategy comprises a drop back state when a ratio of the estimated distance to the CIP vehicle to a minimum following distance is less than a second threshold; and
determining the adjusted speed comprises temporarily decreasing a target speed for the vehicle relative to a set speed for the vehicle in the drop back state.

7. The method of claim 1, further comprising:
detecting the object exiting the zone after autonomously operating the one or more actuators onboard the vehicle in accordance with the longitudinal trajectory determined based at least in part on the adjusted speed; and
after detecting the object exiting the zone:
determining a subsequent longitudinal trajectory for the vehicle within the current lane of travel based at least in part on a set speed for the vehicle, wherein the set speed is different from the adjusted speed; and
autonomously operating the one or more actuators onboard the vehicle in accordance with the subsequent longitudinal trajectory.

8. A vehicle comprising:
one or more sensing devices onboard the vehicle to obtain sensor data for an object in an adjacent lane and a closest in path (CIP) vehicle ahead of the vehicle within a current lane of travel;
one or more actuators onboard the vehicle; and
a controller that, by a processor, identifies the object in a zone relative to the vehicle corresponding to the adjacent lane, determines an estimated amount of time within the zone associated with the object, and in response to determining the estimated amount of time within the zone is greater than a threshold:
determines a longitudinal adjustment strategy to reduce the estimated amount of time within the zone associated with the object based at least in part on an estimated distance to the CIP vehicle;
determines an adjusted speed for the vehicle in accordance with the longitudinal adjustment strategy;
determines a longitudinal trajectory for the vehicle within the current lane of travel based at least in part on the adjusted speed; and
autonomously operates the one or more actuators onboard the vehicle in accordance with the longitudinal trajectory.

9. The vehicle of claim 8, wherein the controller determines longitudinal boundaries for the zone based at least in part on a first speed of the vehicle, wherein determining the estimated amount of time comprises determining the estimated amount of time at least a portion of the object will remain within the longitudinal boundaries based at least in part on a relationship between a second speed of the object and the first speed of the vehicle.

10. The vehicle of claim 9, wherein the controller determines an object type associated with the object, wherein:
determining the longitudinal boundaries comprises determining the longitudinal boundaries based at least in part on the first speed of the vehicle and the object type associated with the object; and
the threshold is influenced by the object type.

11. The vehicle of claim 8, wherein the controller determines an object type associated with the object, wherein the threshold is influenced by the object type.

12. The vehicle of claim 8, wherein:
the longitudinal adjustment strategy comprises a speed up state when the estimated distance is greater than a second threshold; and
the adjusted speed comprises an increased target speed for the vehicle relative to a set speed for the vehicle in the speed up state.

13. The vehicle of claim 8, wherein:
the longitudinal adjustment strategy comprises a drop back state when a ratio of the estimated distance to the CIP vehicle to a minimum following distance is less than a second threshold; and
the adjusted speed comprises a decreased target speed for the vehicle relative to a set speed for the vehicle in the drop back state.

14. The vehicle of claim 8, wherein the controller detects the object exiting the zone after autonomously operating the one or more actuators onboard the vehicle in accordance with the longitudinal trajectory determined based at least in part on the adjusted speed, and after detecting the object exiting the zone, the controller determines a subsequent longitudinal trajectory for the vehicle within the current lane of travel based at least in part on a set speed for the vehicle and autonomously operates the one or more actuators onboard the vehicle in accordance with the subsequent longitudinal trajectory.

15. A non-transitory computer-readable medium comprising executable instructions that, when executed by a processor, cause the processor to:
identify an object in a zone relative to a vehicle corresponding to a lane associated with a same direction of travel for the vehicle adjacent to a current lane of travel for the vehicle;
determine an estimated amount of time within the zone associated with the object; and
in response to determining the estimated amount of time within the zone is greater than a threshold:
determine a longitudinal adjustment strategy to reduce the estimated amount of time within the zone associated with the object based at least in part on an estimated distance to a closest in path (CIP) vehicle ahead of the vehicle within the current lane of travel;
determine an adjusted speed for the vehicle in accordance with the longitudinal adjustment strategy;
determine a longitudinal trajectory for the vehicle within the current lane of travel based at least in part on the adjusted speed; and
autonomously operate one or more actuators onboard the vehicle in accordance with the longitudinal trajectory.

16. The non-transitory computer-readable medium of claim 15, wherein the executable instructions cause the processor to determine longitudinal boundaries for the zone based at least in part on a first speed of the vehicle, wherein determining the estimated amount of time comprises determining the estimated amount of time at least a portion of the object will remain within the longitudinal boundaries based at least in part on a relationship between a second speed of the object and the first speed of the vehicle.

17. The non-transitory computer-readable medium of claim 16, wherein the executable instructions cause the processor to determine an object type associated with the object, wherein:
determining the longitudinal boundaries comprises determining the longitudinal boundaries based at least in part on the first speed of the vehicle and the object type associated with the object; and
the threshold is influenced by the object type.

18. The non-transitory computer-readable medium of claim 15, wherein the executable instructions cause the processor to determine an object type associated with the object, wherein the threshold is influenced by the object type.

19. The non-transitory computer-readable medium of claim 15, wherein:
the longitudinal adjustment strategy comprises a speed up state when the estimated distance is greater than a second threshold; and
the executable instructions cause the processor to temporarily increase a target speed for the vehicle relative to a set speed for the vehicle in the speed up state.

20. The non-transitory computer-readable medium of claim 15, wherein:
the longitudinal adjustment strategy comprises a drop back state when a ratio of the estimated distance to the CIP vehicle to a minimum following distance is less than a second threshold; and
the executable instructions cause the processor to temporarily decrease a target speed for the vehicle relative to a set speed for the vehicle in the drop back state.
